(19) United States
(12) Patent Application Publication
(10) Pub. No.: US 2014/0033585 A1
(43) Pub. Date: Feb. 6, 2014

(54) SCRATCH OFF LICENSE PLATE FRAME

(71) Applicant: DANIEL W. HARRELL, N.M.B., FL (US)

(72) Inventor: DANIEL W. HARRELL, N.M.B., FL (US)

(21) Appl. No.: 13/562,503

(22) Filed: Jul. 31, 2012

(51) Int. Cl. G09F 7/00; B42D 15/00; G09F 3/10

(52) U.S. Cl. 40/209

(57) ABSTRACT

The present invention is to enable consumers to scratch off numbers, letters, or symbols, on license plate frames, and relates to those used on automotive vehicles for advertising messages, and using a phone number, surrounding the automobile license plate and, methods for fabricating the same and, more particularly to apply to the top and or bottom side of a license plate frame an adhesive backed tape or label with a scratch off coating applied to the front side of the adhesive backed tape or label. This scratch off material is usually in the form of an ink which is usually silkscreened or baked on the tape or label, enabling consumers to scratch off the front side of the tape or label, revealing numbers or letters or symbols used in a standard message or phone number or web site address.

### BACKGROUND OF THE INVENTION

1. Field of the Invention

The present invention pertains to license plate frames for an automobile license plate and the like and, more to a license plate frame adapted to display user-configurable indicia. Such holders may be made of plastic, or metal, or other suitable materials.

2. Description of the Prior Art

In the United States, automobile license plates and license plate frames are of standardized construction. The license plate and license plate frame are generally rectangular with predetermined external dimensions. Standardized construction of the automobile license plate also includes standardized locations for the placement of the mounting holes formed through the license plate and the license plate frame. The standardized mounting holes include two mounting holes adjacent an upper edge of the license plate in predetermined locations and a pair of lower mounting holes positioned adjacent the lower edge of the license plate in predetermined positions.

With the benefit of the standardized construction of license plates and license plate frames with respect to external dimensions and positioning of mounting holes, automobile manufacturers construct automobiles for the U S markets with locations on the automobiles prepared to accept license plates and license plate frames of the predetermined construction.

People seem to have a universal urge to personalize their belongings. Such personalization typically takes the form of their name or initials, an affiliation with particular group, their support of cause, organizations, sports team etc. Automobiles or other vehicles belonging to other people are no exception. Another way such customization may be accomplished is by using a customized license plate frame to secure the license plate of a vehicle. Many off the shelf frames bearing catch phrases such as “I'd RATHER Be GOLFING”, “My OTHER CAR IS A BROOM”, or a custom license plate frames displaying indicia advertising a car dealership are well known.

While such license plate frames may fill the needs of a certain percentage of the population, those truly driven by the customization urge are not satisfied with such solutions. Consequently, while these particular types of frames may provide slogans or advertising, they do little to fill the need for true personalization or customization. Many people desire to have their own message and or phone number on a license plate frame leaving it very timely and costly to obtain a custom license frame. The present invention will make it easier for consumers desiring a custom license plate frame including a phone number, or web site address, and or a message. Presently instant lottery games and the likes are using a scratch off system usually in the form of a coating of scratch off paint which is silk screened or baked directly on to the ticket surface, over the imprinting thereon. Once this coating is removed, the purchaser can determine if he/she holds a winning ticket.

The present invention will make it easier for consumers to create their own custom license plate frame including a phone number, or web page address, and or a message. Using the current methods of production it is the intention to apply an adhesive backed tape or label with the scratch off paint or ink which is commonly applied by way of silk screen or baked on thereof and adhere the same to a license plate frame. Removal of the adhesive backed tape or label will render the scratch off license plate frame unusable. With the scratch off license plate frame consumers can remove the scratch off material from the license plate frame revealing the surface of the tape or label in the style and shape of the desired numbers, or letters, or symbols, thus creating a phone number, and or message. One example one might want to remove the scratch off revealing the letters “FOR SALE” as a message and 888-888-8888 as a phone number above or below the message creating a scratch off license plate frame.

### SPECIFICATION

The present invention is to enable consumers to scratch off numbers, letters, or symbols, on license plate frames, and relates to those used on automotive vehicles for advertising messages, and using a phone number, surrounding the automobile license plate and, methods for fabricating the same and, more particularly to apply to the top and or bottom side of a license plate frame an adhesive backed tape or label with a scratch off coating applied to the front side of the adhesive backed tape or label and adhering the same to a license plate frame, enabling consumers to remove the scratch off of the front side of the tape or label revealing the face of the tape or label in the shape and or style of numbers or letters or symbols used in a standard message or phone number or web site address. Removal of the scratch of tape or label from the license plate frame renders the license plate frame unusable.

Leaving areas of unapplied scratch off coating on the front side of the tape or label as alignment marks indicative of the location for each number, or letter, or symbols used in a standard phone number, or message, or web site address are intended to be included within the scope of the claims.

However other modifications and equivalents other than those disclosed concepts such as those which readily occur to one skilled in the art is intended to be included within the scope of the claims which are appended hereto.

### DESCRIPTION OF THE PREFERRED EMBODIMENT

Referring now to the several drawing figures in which identical elements are numbered identically throughout, a description of the preferred embodiment will now be provided.

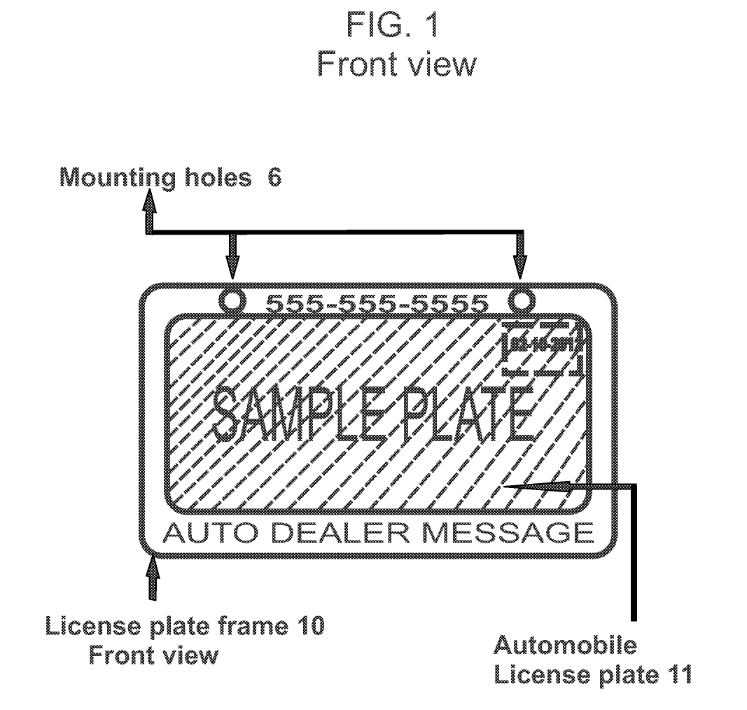

FIG. 1 shows a front view of a standardized automobile license plate frame 10 on the front side of a license plate 11. The license plate 11 includes a sheet metal body having a top edge and a spaced apart bottom edge. Joining the top edge and the bottom edge are side edges. It is recognized in the industry that license plates 11 are made of standardized construction such that the periphery defined by edges is of predetermined size and shape. The license plate 11 also includes a first and second pair of mounting holes 6 positioned adjacent to the top and or bottom edges. Again, as recognized in the industry, the number and location of the mounting holes 6 are predetermined by industry standards. As such industry standards are for the license plate 11, so are the industry standards for a license plate frame 10 with a first and or a second pair of mounting holes 6 positioned adjacent to the top and or the bottom.

While the shape of the license plate 11 and the license plate frame 10 is standard throughout the United States, the location and the edges are sized for the outer license plate frame 10 perimeter to be substantially coextensive with the license plate 11 periphery when the license plate frame 10 is placed against the license plate 11 in overlying relation. Automobile manufactures construct automobiles for the US markets with locations on the automobiles prepared to accept license plates 11 and license plate frames 10 of the predetermined construction. For example, an automobile manufacturer will provide a location on the bumper of a vehicle with the location sized to receive the license plate 11 and the license plate frame 10.

As automobile manufactures provide locations on automobiles for the license plate 11, automobile dealers often provide license plate frames 10 of the predetermined construction with a dealer message and a phone number located on the license plate frame 10 attached to the automobiles, sold to consumers.

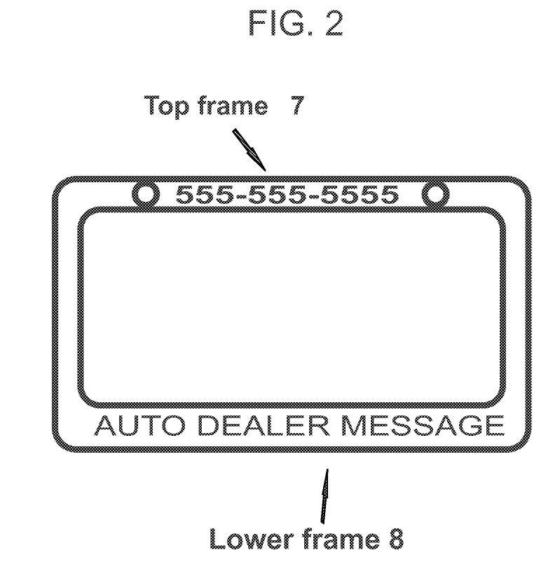

FIG. 2

Shows a license plate frame 10 as used by automobile dealers using a phone number and a message as advertisement at the top frame 7 and the lower frame 8, provided on automobiles.

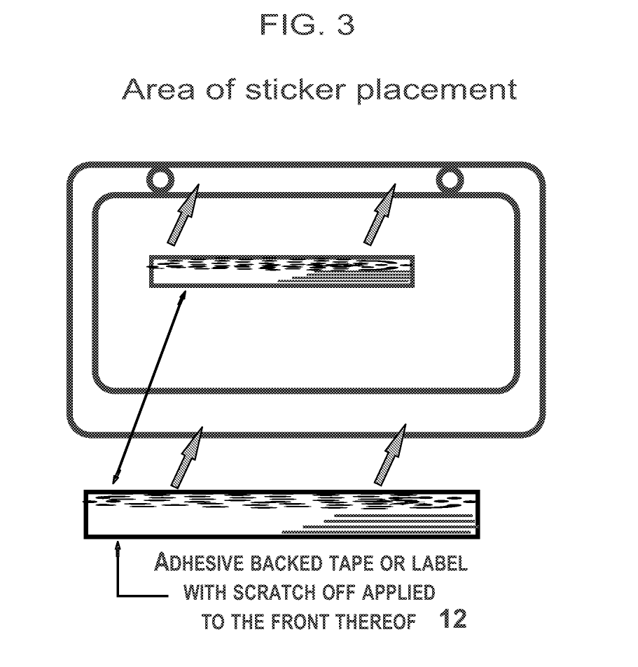

FIG. 3

Shows the front view of a license plate frame 10 and the locations at the top frame 7 and the lower frame 8, where an adhesive backed tape or label with a scratch off coating applied to the front side thereof 12, will be adhered thereto, thus creating a Scratch off license plate frame, enabling consumers to remove the opaque ink of the front side of the tape or label revealing the face of the tape or label in the desired style of numbers or letters or symbols used in a standard message and or phone number and or web site address. One example might be a consumer scratches off a ten digit phone number and the letters “FOR SALE” as a message thus creating a much easier to customize a license plate frame 10. Removal of the scratch off tape or label from the license plate frame 10 renders the license plate frame 10 unusable.

What is claimed:

1. A license plate frame adapted to receive and substantially surround the perimeter of a license plate while exposing indicia bearing face of said license plate for viewing, the license plate frame and attached thereto with an adhesive backed tape or label, and shall be applied to the upper and or lower portion of the license plate frame, constructed of plastic, metal, or other suitable material.

2. A combination according to claim 1,
Whereas the license plate frame consist of a license plate frame attached thereto an adhesive backed tape or tapes, or label, or labels, located on the upper and or lower portion of the frame, above or below the message and or phone number location, an opaque ink coating applied by silk screen or baked thereon and applied to the front side of the adhesive backed tapes or labels, known in the industry as and used by one skilled in the art as ‘scratch off ink’, as applied together creating a Scratch Off License Plate Frame, displaying user configurable Indicia thereupon, consumers can scratch off any desired numbers, and or letters, and or symbols in the desired locations of each number, or letter, or symbol used with a phone number, or message, or web address.

3. A combination according to claim 1,
Whereas the Scratch Off License Plate Frame consist of a license plate frame attached thereto an adhesive backed tape or tapes, and or label, or labels, and attached thereon an opaque ink coating known as and used by one skilled in the art as scratch off ink, applied to the front side of the adhesive backed tapes or labels, leaving areas of unapplied scratch off coating on the front side of the tape or label may be also known as alignment marks indicative of the location for each number, or letter, or symbol used in a standard phone number, or message, or web site address are intended to be included within the scope of the claims. However other modifications and equivalents other than those disclosed concepts such as those which readily occur to one skilled in the art is intended to be included within the scope of the claims which are appended hereto.
